(19) United States
(12) Patent Application Publication
(10) Pub. No.: US 2020/0283041 A1
(43) Pub. Date: Sep. 10, 2020

(54) EQUIPMENT CADDIE

(71) Applicant: MARIO ALBERTO CENTENO, HIALEAH, FL (US)

(72) Inventor: MARIO ALBERTO CENTENO, HIALEAH, FL (US)

(21) Appl. No.: 16/292,025

(22) Filed: Mar. 4, 2019

(51) Int. Cl. B62B 1/16; A45C 13/26; A45C 5/14; A63B 60/60; A63B 71/00

(52) U.S. Cl. CPC B62B 1/16; A45C 13/262; A45C 5/14; A45C 2009/002; A63B 71/0045; A63B 2225/68; A63B 60/60

(57) ABSTRACT

An equipment caddie that comprises of an oblong housing that is on at least two wheels. The caddie has a retractable handle and a two-piece cover. The first part of the cover defines a compartmental housing that defines at least one cylinder wherein bats or elongated items can be stored. The cylinder(s) defines drains that will allow precipitation to exit the cylinder if the precipitation enters the cylinder. The second part of the two-piece cover is a seat that is pivotally attached to the compartmental housing. In a preferred embodiment, the caddie will define side openings that will allow a user to lift the caddie on to a vehicle.

### BACKGROUND

The present invention is directed to an equipment caddie that will allow athletes to carry their softball or baseball equipment in an organized manner and provide the athletes a place to rest while not on the field.

The inventor of the present invention conceived the equipment caddie when traveling with his children whom played organized baseball. He was one of the coaches on the team and realized that between games, often, the kids had nowhere to sit. On many occasions, the bucket that he used to carry balls was taken by his children and used as a stool.

The need to provide his children with a stool during games led to the conception of the present invention. Yet he realized that simply providing a bucket with wheels that had a retractable handle was not enough. He had to design a bucket that could carry at least two bats and his children's equipment so that the equipment would not be soaked during summer storms.

In summer leagues, parents transport luggage, baseball equipment, tents, lounge chairs, coolers, baseball equipment bag carries and food in vehicles, so he realized that adding another thing to carry in vehicles was not feasible. He chose to eliminate the baseball equipment bag carriers with the present invention. The present invention provides his children with a stool that is an equipment carrier.

For the foregoing reason there is a need for an equipment caddie that can used by athletes as a stool and as an equipment carrier.

### SUMMARY

The present invention describes an equipment caddie that is used by athletes as a stool and as an equipment carrier.

The equipment caddie comprises of an oblong housing that is on at least two wheels. The caddie has a retractable handle and a two-piece cover. The first part of the cover defines a compartmental housing that defines at least one cylinder wherein bats or elongated items can be stored. The cylinder(s) defines drains that will allow precipitation to exit the cylinder if the precipitation enters the cylinder. The second part of the two-piece cover is a seat that is pivotally attached to the compartmental housing. In a preferred embodiment, the caddie will define side openings that will allow a user to lift the caddie on to a vehicle.

Embodiments of the equipment caddie will define further compartments within the oblong housing and hooks, brackets or holders that will support equipment.

An object of the present invention is to provide an equipment caddie that can be used as a stool.

Another object of the present invention is to provide an equipment caddie that can be used to house and transport athletic equipment.

Yet a further object of the present invention is to provide an equipment caddie that has side vents.

### DRAWINGS

These and other features, aspects, and advantages of the present invention will become better understood with regards to the following description, appended claims, and drawings where:

FIG. 1 is a perspective view of the present invention wherein the seat covers the oblong housing of the present invention;

FIG. 2 is a perspective view of the present invention wherein the seat cover is upright and does not cover the oblong housing;

FIG. 3 is a top plan view of the present invention that shows the seat in a down position;

FIG. 4 is a top plan view of the present invention that shows the inner pockets or compartment of the invention;

FIG. 5 is a side view of the present invention; and

FIG. 6 is a side view that shows one of the cylinders of the present invention.

### DESCRIPTION

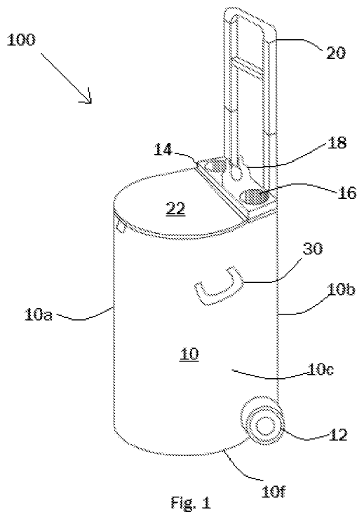

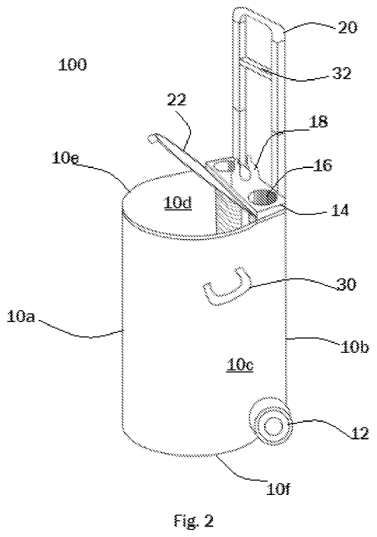

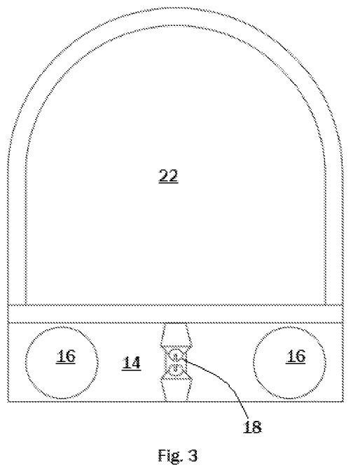

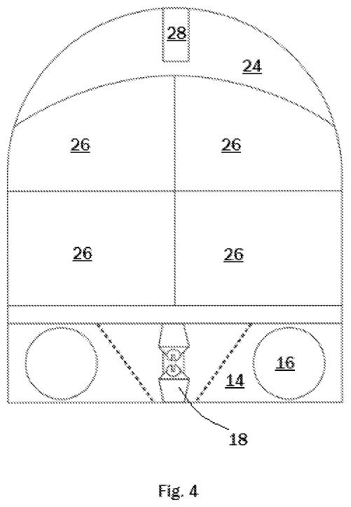

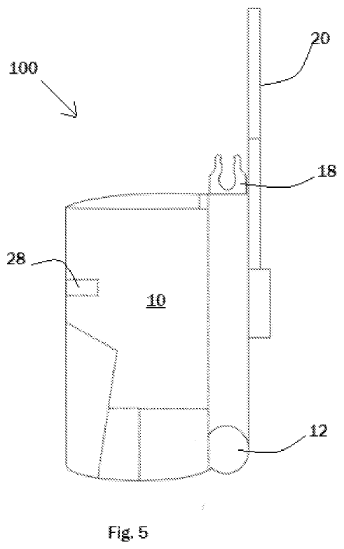

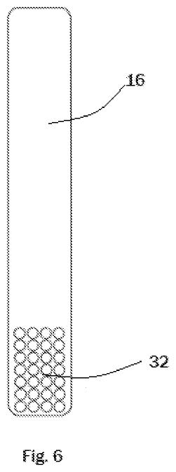

As seen in FIGS. 1-6, the present invention describes an equipment caddie 100. The the caddie 100 comprises an oblong housing 10 that has a front 10a, a rear 10b, a left 10c, a right 10d, a top 10e and a bottom side 10f, wherein the front side 10a is circular, the rear side 10b is planar and the left 10c and right sides 10d connect the front side 10a to the rear side 10b, the bottom side 10f is closed and a set of wheels 12 are attached to the rear side 10b at a position that is adjacent to the bottom side 10f, the top side 10e defines an aperture. A first compartmental housing 14 is within and attached to the rear side 10b of the oblong housing 10, the first compartmental housing 14 defines at least one cylinder 16 that runs from the top side 10e of the oblong housing 10 toward the bottom side 10f of the oblong housing 10, and the first compartmental housing 14 defines a clamp 18 that is centered between the left side 10c and the right side 10d of the oblong housing 10. A telescoping handle 20 is fixedly attached to the rear side 10b of the oblong housing 10. And, a seat cover 22 that is pivotally attached to the first compartmental housing 14.

The oblong housing 10 was designed to accommodate a two-part cover. The first part of the cover (the first compartmental housing 14) holds elongated equipment in the rear side 10b of the oblong housing 10. The second part of the cover is a seat 22 that is pivotally attached to the first part of the cover. The cover is designed to allow a user to sit on the equipment caddie 100 while having at least one bat within the cylinders of the equipment caddie 100. This design helps the athlete secure his equipment within a single carrier and allows the caddie to be used a stool. The seat 22 can be a cushion.

A first pocket 24 can be attached to the oblong housing 10 at a position that is within and on the front side 10a of the oblong housing 10. The first pocket 24 can be used to store a glove. The first pocket 24 can be designed to be a molded glove compartment.

A pair of lower compartments 26 may also be defined within and on the bottom side 10f of the oblong housing 10. The pair of lower compartments 26 are designed to hold shoes, cleats or any other valuable.

An embodiment of the present invention may have a holder 28 that is attached to the oblong housing 10 at a position that is within the oblong housing and above the first pocket 24. The holder 28 is designed to hold hanging items, such as batting gloves.

In preferred embodiments of the present invention the oblong housing 10 defines a pair of carrying openings 30, each opening being on the left side 10c and the right side 10d of the oblong housing 10 and positioned at least three inches from the top side 10e of the oblong housing 10. The carrying openings 30 allow a user a place to insert his or her hands to lift the equipment caddie 100. The carrying openings 30 also serve as vents that allow air to pass through the equipment caddie 100.

In an embodiment, the handle 20 defines a lower bracket 32 that is used to receive a hooked accessory.

The cylinders 16 of the present invention, in preferred embodiments, shall define a drain 32. The drain 32 will allow precipitate that enters the cylinders 16 to pour out of the cylinders 16.

In an embodiment of the present invention, the first compartmental housing 14 defines a clamp 18 that is centered between the left side 10c and the right side 10d of the oblong housing 10. The clamp 18 is used to secure a helmet on to the equipment caddie 100.

An advantage of the present invention is that it provides an equipment caddie that is used as a stool.

Another advantage of the present invention is that it provides an equipment caddie that is used to house and transport athletic equipment.

Yet a further advantage of the present invention is that it provides an equipment caddie that has side vents.

While the inventor's above description contains many specificities, these should not be construed as limitations on the scope, but rather as an exemplification of several preferred embodiments thereof. Accordingly, the scope should not be determined by the embodiments illustrated, but by the appended claims and their legal equivalents.

What is claimed is:

1. An equipment caddie, the caddie comprises:
An oblong housing that has a front, a rear, a left, a right, a top and a bottom side, wherein the front side is circular, the rear side is planar and the left and right sides connect the front side to the rear side, the bottom side is closed and a set of wheels are attached to the rear side at a position that is adjacent to the bottom side, the top side defines an aperture;
A first compartmental housing is within and attached to the rear side of the oblong housing, the first compartmental housing defines at least one cylinder that runs from the top side of the oblong housing toward the bottom side of the oblong housing;
A telescoping handle is fixedly attached to the rear side of the oblong housing; and
A seat cover that is pivotally attached to the first compartmental hosing.

2. The equipment caddie of claim 1, the caddie comprises a first pocket that is attached to the oblong housing at a position that is within and on the front side of the oblong housing.

3. The equipment caddie of claim 2, the caddie comprises of at least a pair of lower compartments that are defined within the bottom side of the oblong housing.

4. The equipment caddie of claim 3, the caddie comprises a holder that is attached to the oblong housing at a position that is within the oblong housing and above the first pocket.

5. The equipment caddie of claim 4, wherein the oblong housing defines a pair of carrying openings, each opening being on the left side and the right side of the oblong housing and positioned at least three inches from the top side of the oblong housing.

6. The equipment caddie of claim 5, wherein the handle defines a lower bracket that is used to receive a hooked accessory.

7. The equipment caddie of claim 1, wherein each cylinder has a drain.

8. The equipment caddie of claim 1, wherein the first compartmental housing defines a clamp that is centered between the left side and the right side of the oblong housing.
